(19) United States
(12) Patent Application Publication
(10) Pub. No.: US 2024/0138305 A1
(43) Pub. Date: May 2, 2024

(54) Sorrel Deseeder Machine

(71) Applicant: Turner Innovations Ltd., Manchester (JM)

(72) Inventors: Oral Oneal Turner, Manchester (JM); Allison Deborah Turner, Manchester (JM)

(73) Assignee: Turner Innovations Ltd., Manchester (JM)

(21) Appl. No.: 18/382,614

(22) Filed: Oct. 23, 2023

Related U.S. Application Data
(60) Provisional application No. 63/419,845, filed on Oct. 27, 2022.

(51) Int. Cl. A01D 45/30

(52) U.S. Cl. CPC A01D 45/30; A01D 45/065

(57) ABSTRACT

A sorrel de-seeder that facilitates the stripping of sepals from the seed of a sorrel bud.

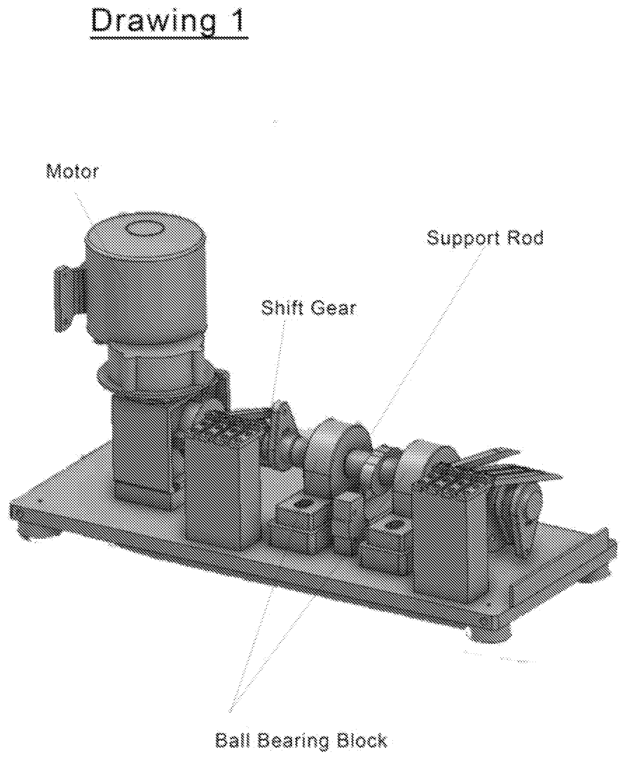

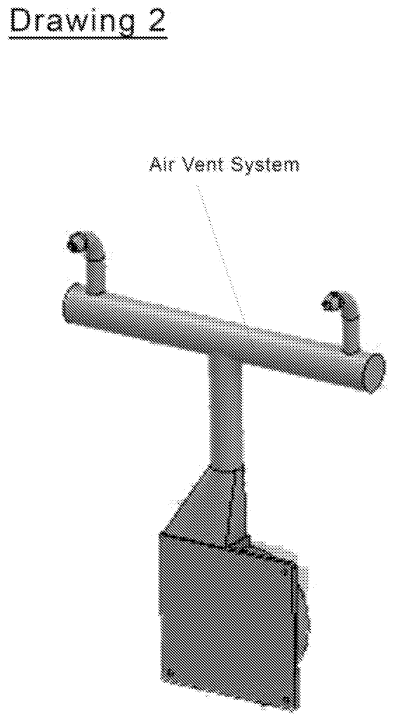

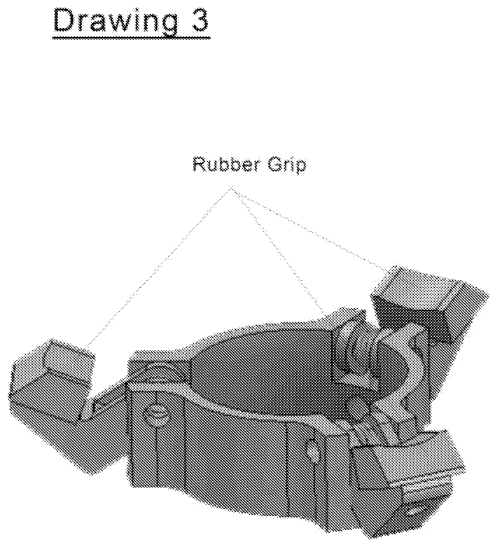

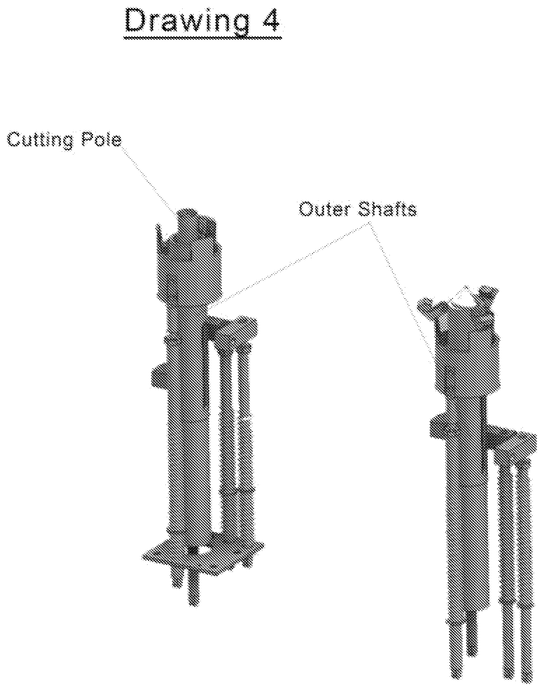

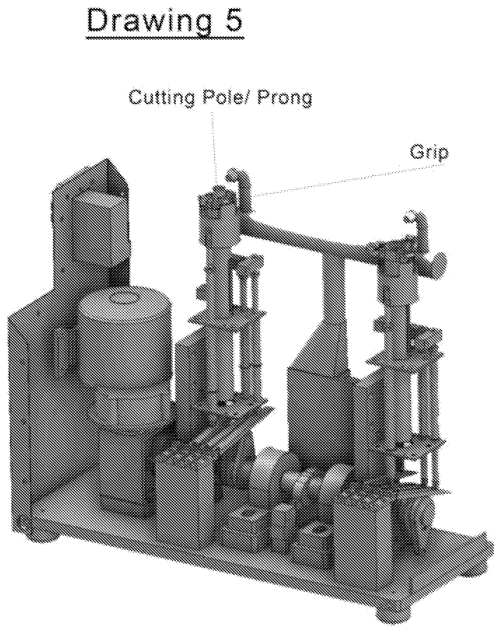

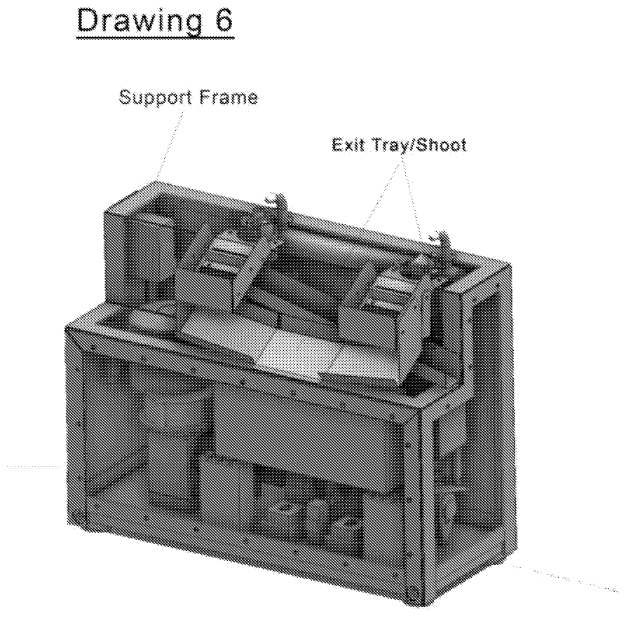

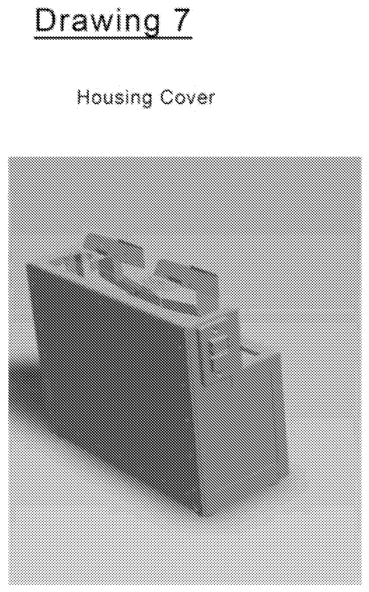

### BACKGROUND

### Field of the Invention

The present invention is directed to a automated cutting apparatus, but not exclusively, this invention relates to cutting apparatus for cutting vegetable material, for example buds, such as buds of the plant Roselle (Hibiscus sabdariffa).

This invention may also relate to core removal apparatus. More particularly, but not exclusively, this invention relates to cutting apparatus for removing cores from plant matter, for example the removal of the seed capsule from the calyx of a plant, such as Roselle. This invention may also relate to methods of using cutting apparatus described above.

### Description of the Related Art

It is known to use the sepals from the calyces of the Roselle, known as sorrel in subtropical countries, to produce a beverage. It is also known to use the sepals/calyces for food coloring and flavoring and other food applications and has medicinal values.

The sepals and calyces have to be separated from the central seed capsule prior to use. Present methods and apparatus to remove the seed capsule are wasteful in terms of the proportion of the sepals and calyces lost.

### SUMMARY

The objective of the invention is to make the process of separating the sepals and calyces from the central seed capsule faster than the hand method to increase production.

The other objective of the invention is to reduce the number of manual labor need to achieve high yield and reduce production cost.

### BRIEF DESCRIPTION OF THE DRAWINGS

Drawing 1—Ball bearing block provide for good sheave rotation with the lowest possible friction and is connected a support rod that rotates with a shift gear that's driven by a motor.

Drawing 2—Air vent system is powered by an air blower. When the sorrel is cut the seed drops into the near seed exit shoot (see drawing 6). The sepals which carries less weight is blown forward and the sepals go into the exit tray (see drawing 6)

Drawing 3—Rubber grip closes and holds the uncut sorrel in place ready to be cut and opens to release it. The sorrel is fed by hand into the grip shafts while it is open that open by the outer shaft moves that moves up and down.

Drawing 4—An outer shaft supports and houses the cutting pole that moves up and down to cut and push off the seed that is driven by the crank shaft.

Drawing 5—The machine uses two prongs that come up to cut alternatively, one at a time. This gives the person feeding the machine time to pick up and place one sorrel per second into the grip, they open and close by a timing system while the cutting pole is up to cut the sorrel. The grip opens with the motion of the shaft moving to release the sorrel.

Drawing 6—The support frame holds all the components in place and is the frame for the cover.

Drawing 7—The cover supports the hopper that holds the sorrel and it supports the motor blower and all components.

### DETAILED DESCRIPTION

The Sorrel De-Seeder is an automated machine that facilitates the stripping of the sepals also known as calyces from the seed pod of the plant Roselle (Hibiscus sabdariffa) also known as sorrel.

The machine has a two prong system that is hand feed uncut sorrel buds by hand. A hopper sits at the top of the machine that is loaded with uncut sorrel buds. One sorrel bud is picked up in one hand and put into a grip (with the base of the sorrel at the bottom) while its open, the grip closes holding the sorrel in place and a cutting pole comes up and cuts through the base of the sorrel cutting the seed from the sepals this is repeated on the other side.

Once the sepal is cut, the pole pushes off the seed, the natural weight of the seed cause it to roll down into a catching shoot which exits out to one side of the machine. The sepals are less than half the weight of the seed once separated this allows for the air coming from the blower system to carry the sepals forward enough to fall into the exit tray.

The machine is uses a motor, power supply and blower.

We claim:

1. A sorrel de-seeder, comprising:
a sorrel bud grip configured hold a sorrel bud, wherein a sorrel bud base faces said sorrel bud grip;
a cutting pole movable in relation to the sorrel bud grip, wherein movement of the cutting pole cuts through the base of said sorrel bud gripped by the sorrel bud grip, whereby the sorrel seed is removed from the sorrel sepals;
a motor configured to drive a cam coupled to said cutting pole, said cam reciprocally moves said cutting pole to cut through the base of said sorrel bud gripped by the sorrel bud grip.
